(19) United States
(12) Patent Application Publication
(10) Pub. No.: US 2025/0057234 A1
(43) Pub. Date: Feb. 20, 2025

(54) AEROSOL GENERATING DEVICE, AND HEATER OF AEROSOL GENERATING DEVICE

(71) Applicant: SHENZHEN FIRST UNION TECHNOLOGY CO., LTD., Shenzhen, Guangdong (CN)

(72) Inventors: Zuqiang QI, Shenzhen, Guangdong (CN); Zhongli XU, Shenzhen, Guangdong (CN); Yonghai LI, Shenzhen, Guangdong (CN)

(73) Assignee: SHENZHEN FIRST UNION TECHNOLOGY CO., LTD., Shenzhen, Guangdong (CN)

(21) Appl. No.: 18/723,226

(22) PCT Filed: Dec. 8, 2022
(86) PCT No.: PCT/CN2022/137622

§ 371 Date: Jun. 21, 2024

(30) Foreign Application Priority Data
Dec. 21, 2021 (CN) 202123257899.X

(51) Int. Cl. A24F 40/465; A24F 40/20; A24F 40/51

(52) U.S. Cl. CPC A24F 40/465; A24F 40/51; A24F 40/20

(57) ABSTRACT

An aerosol generating device and a heater are provided. The aerosol generating device includes a chamber for receiving an aerosol generating product, a magnetic field generator for generating a varying magnetic field, and a heater for heating the aerosol generating product. The heater includes a susceptor and a temperature sensor. A part of the susceptor extends in the chamber. The susceptor is penetrated by the varying magnetic field to generate heat and has a hollow extending in an axial direction. The temperature sensor senses a temperature of the susceptor. A part of the temperature sensor is located in the hollow. A hole penetrates from an outer surface of the susceptor to the hollow. The hole provides a path for operating the temperature sensor, so that the temperature sensor is connected to the susceptor.

### CROSS-REFERENCE TO RELATED APPLICATION

This application claims priority to Chinese Patent Application No. 202123257899.X, filed with the China National Intellectual Property Administration on Dec. 21, 2021 and entitled “AEROSOL GENERATING DEVICE, AND HEATER OF AEROSOL GENERATING DEVICE”, which is incorporated herein by reference in its entirety.

### TECHNICAL FIELD

This application relates to the field of aerosol generation technologies, and in particular, to an aerosol generating device, and a heater of the aerosol generating device.

### BACKGROUND

Smoking products (such as cigarettes and cigars) burn tobacco during use to produce tobacco smoke. Attempts are made to replace these tobacco-burning products by making products that release compounds without burning.

An example of this type of products is a heating device that releases compounds by heating rather than burning materials. For example, the materials may be tobacco or other non-tobacco products. The non-tobacco products may include or not include nicotine. In another example, in the prior art, an electromagnetic induction heating-type heating device is provided, which heats a tobacco or non-tobacco product by using a susceptor that can be penetrated by a varying magnetic field to generate heat, thereby generating an inhalable aerosol. A known heating device senses a temperature of a susceptor in real time by encapsulating a temperature sensor after drilling a hole in the susceptor. However, it is difficult to perform production and processing by drilling the hole in the susceptor and encapsulating the temperature sensor.

### SUMMARY

An embodiment of this application provides an aerosol generating device, configured to heat an aerosol generating product to generate an aerosol; and including:
a chamber, for receiving the aerosol generating product;
a magnetic field generator, configured to generate a varying magnetic field; and
a heater, configured to heat the aerosol generating product, where the heater includes:
a susceptor, where at least a part of the susceptor extends in the chamber, and the susceptor is configured to be penetrated by the varying magnetic field to generate heat; and the susceptor has a hollow extending in an axial direction;
a temperature sensor, configured to sense a temperature of the susceptor, where at least a part of the temperature sensor is located in the hollow; and
a hole, penetrating from an outer surface of the susceptor to the hollow, where the hole is configured for providing a path for operating the temperature sensor, so that the temperature sensor is connected to the susceptor.

As a further improvement of the foregoing technical solution, at least a part of the temperature sensor is visible through the hole.

As a further improvement of the foregoing technical solution, the hole substantially extends in a radial direction of the susceptor.

As a further improvement of the foregoing technical solution, a size of the hole in a length direction of the susceptor is larger than a size of the hole in a circumferential direction of the susceptor.

As a further improvement of the foregoing technical solution, the size of the hole in the length direction of the susceptor ranges from 1.2 mm to 2 mm; and/or the size of the hole in the circumferential direction of the susceptor ranges from 0.5 mm to 1.0 mm.

As a further improvement of the foregoing technical solution, a sectional area of the hole is smaller than 2 mm².

As a further improvement of the foregoing technical solution, the hollow includes a termination end terminating in the susceptor, and the hole is close to the termination end.

As a further improvement of the foregoing technical solution, the heater further includes: a protective layer, bonded to the outer surface of the susceptor and covering the hole.

As a further improvement of the foregoing technical solution, the temperature sensor includes a first couple wire and a second couple wire connected to the susceptor; and the first couple wire and the second couple wire are made of different materials.

Another embodiment of this application further provides a heater of an aerosol generating device, including:
a susceptor, configured to be penetrated by a varying magnetic field to generate heat, and constructed into an elongated shape extending in an axis, where the susceptor has a hollow extending in the axis;
a temperature sensor, configured to sense a temperature of the susceptor, where at least a part of the temperature sensor is located in the hollow; and
a hole, penetrating from an outer surface of the susceptor to the hollow, where the hole is for providing a path for operating the temperature sensor, so that the temperature sensor is fixedly connected to the susceptor.

For the foregoing heater, it is more convenient to connect the temperature sensor to the susceptor through the hole.

### BRIEF DESCRIPTION OF THE DRAWINGS

One or more embodiments are exemplarily described with reference to corresponding figures in the accompanying drawings, and the exemplary descriptions do not constitute a limitation on the embodiments. Elements in the accompanying drawings that have same reference numerals are represented as similar elements, and unless otherwise particularly stated, the figures in the accompanying drawings are not drawn to scale.

FIG. 1 is a schematic diagram of an aerosol generating device according to an embodiment of this application;

FIG. 2 is a schematic diagram of an embodiment of a heater in FIG. 1;

FIG. 3 is a schematic exploded view of the heater in FIG. 2 from an angle of view;

FIG. 4 is a schematic sectional view of a susceptor in FIG. 3 from an angle of view; and

FIG. 5 is a schematic sectional view of the heater in FIG. 2 from an angle of view.

### DETAILED DESCRIPTION

For ease of understanding of this application, this application is described in further detail below with reference to the accompanying drawings and specific implementations.

An embodiment of this application provides an aerosol generating device. Refer to FIG. 1. Construction of the aerosol generating device may include:
a chamber, where an aerosol generating product A is removably received in the chamber;
a magnetic field generator, for example, an induction coil 50, configured to generate a varying magnetic field under an alternating current;
a heater 30, where at least a part of the heater extends in the chamber, and the heater is configured to be inductively coupled to the induction coil 50, and be penetrated by the varying magnetic field to generate heat, to heat the aerosol generating product A such as a cigarette, so that at least one component of the aerosol generating product A is evaporated, to form an aerosol for inhalation;
a cell 10, where the cell 10 is a rechargeable direct current cell, and is capable of outputting a direct current; and
a circuit 20, connected to the rechargeable cell 10 through a suitable current, and configured to convert the direct current outputted by the cell 10 into an alternating current with a suitable frequency and supply the alternating current to the induction coil 50.

Based on an arrangement of a product in use, the induction coil 50 may include a cylindrical induction coil wound into a helical shape, as shown in FIG. 1. The cylindrical induction coil 50 wound into the helical shape may have a radius r ranging from about 5 mm to about 10 mm, and the radius r may be about 7 mm in particular. A length of the cylindrical induction coil 50 wound into the helical shape may range from about 8 mm to about 14 mm, and a quantity of turns of the induction coil 50 may range from about 8 turns to 15 turns. Correspondingly, an internal volume may range from about 0.15 cm³ to about 1.10 cm³.

In a more preferred implementation, a frequency of the alternating current supplied to the induction coil 50 by the circuit 20 ranges from 80 KHz to 500 KHz; and more specifically, the frequency may range from about 200 KHz to about 300 KHz.

In a preferred embodiment, a direct current supply voltage provided by the cell 10 ranges from about 2.5 V to about 9.0 V, and an amperage of the direct current provided by the cell 10 ranges from about 2.5 A to about 20 A.

In a preferred embodiment, the heater 30 is substantially in a pin, needle, rod, or blade shape, which is advantageous for insertion into the aerosol generating product A. In addition, the heater 30 may have a length of about 12 millimeters, a width of about 4 mm, and a thickness of about 0.5 mm, and may be made of grade 430 stainless steel (SS430). In an alternative embodiment, the heater 30 may have a length of about 12 mm, a width of about 5 mm, and a thickness of about 0.5 mm, and may be made of grade 430 stainless steel (SS430). In another varying embodiment, the heater 30 may also be constructed into a cylindrical or tubular shape. During use, a chamber for receiving the aerosol generating product A is formed in inner space of the heater 30, and an aerosol for inhalation is generated by heating an outer periphery of the aerosol generating product A. These heaters 30 may also be made of grade 420 stainless steel (SS420) and an alloy material (for example, permalloy) including iron/nickel.

In an embodiment shown in FIG. 1, the aerosol generating device further includes a support 40 configured to arrange the induction coil 50 and the heater 30, and a material of the support 40 may include a non-metallic material with high temperature resistance such as PEEK or ceramic. In an implementation, the induction coil 50 is fixed on an outer wall of the support 40 in a winding manner. In addition, as shown in FIG. 1, a hollow of the support 40 is in a tubular shape, and the foregoing chamber for receiving the aerosol generating product A is formed in a part of space of the tubular hollow.

In an optional implementation, the heater 30 is prepared by using the foregoing susceptive materials; or the heater 30 is obtained by forming a susceptive material coating on an outer surface of a substrate material with heat resistance, such as non-susceptive ceramic, through electroplating, depositing, or the like.

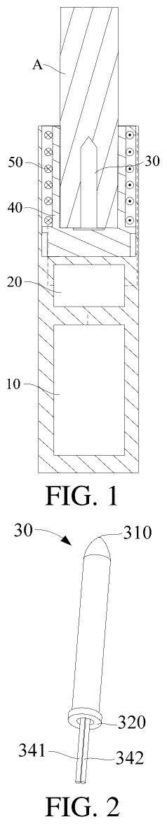

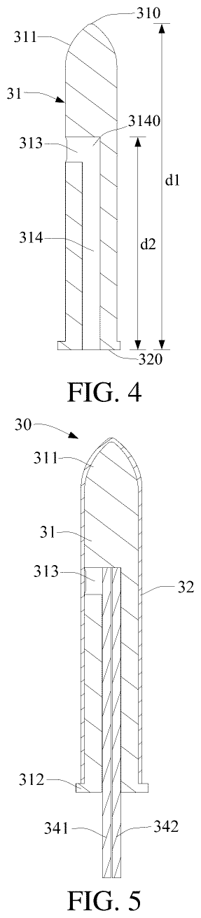

Further, FIG. 2 to FIG. 5 are schematic diagrams of the heater 30 according to an embodiment. The heater 30 in this embodiment has a free front end 310 and a tail end 320 opposite in a length direction; and the free front end 310 is exposed in the chamber after assembly, and the tail end is hidden because the tail end is connected to a housing or a stationary component of the aerosol generating device. Further, the heater 30 includes:
a susceptor 31 in a pin, needle, or rod shape, where the susceptor 31 includes the foregoing susceptive materials, and can be penetrated by the varying magnetic field to generate heat; the free front end 310 and the tail end 320 of the heater 30 are respectively defined by two ends of the susceptor 31 in the length direction;
the susceptor 31 has a tapered part 311 close to the free front end 310 to form a tapered tip at the free front end 310, which is advantageous for insertion into the aerosol generating product A; the susceptor 31 has a base 312 extending radially outward at the tail end 320; and the base 312 is convex relative to other parts of the susceptor 31, so that the aerosol generating device can support the heater 30 by clamping or holding the base 312 during assembly, to make the heater 30 stably assembled.

In some optional implementations, the susceptor 31 is prepared by using the foregoing susceptive metal or alloy, for example, magnetic stainless steel, nickel-iron alloy, or iron-aluminum alloy. In some optional implementations, the susceptor 31 is prepared through a process such as machining, powder metallurgy, or in-mold injection molding.

In some optional implementations, the susceptor 31 has an outer diameter of about 2.0 mm to 3.0 mm and an extension length d1 of about 12 mm to 20 mm.

Further, the susceptor 31 further includes:
a hollow 314, extending in the susceptor 31 in an axial direction of the susceptor 31.

The hollow 314 has an extension length d2 of about 8 mm to 12 mm in the axial direction of the susceptor 31, and an inner diameter of about 1.0 mm to 2.5 mm; and the hollow 314 has a first end 3140 close to the free front end 310 in the length direction, and the first end 3140 is located in the susceptor 31 and terminates at the susceptor 31, and a second end of the hollow 314 is an opening at the tail end 320.

Further, the susceptor 31 further includes:
a temperature sensor, extending from the opening of the hollow 314 at the tail end 320 into the hollow 314. In the embodiment shown from FIG. 2 to FIG. 5, the temperature sensor includes a first couple wire 341 and a second couple wire 342 connected to the susceptor 31; and the first couple wire 341 and the second couple wire 342 are prepared by respectively using different couple materials, so that a thermocouple configured to detect a temperature of the heater 30 may be formed between the first couple wire 341 and the second couple wire 342. For example, the first couple wire 341 and the second couple wire 342 are prepared by using two different materials in couple materials such as nickel, nickel-chromium alloy, nickel-silicon alloy, nickel-chromium-copper, constantan, and iron-chromium alloy. The first couple wire 341 and the second couple wire 342 have outer diameter sizes of about 0.2 mm to 0.8 mm.

Further, in an implementation, the susceptor 31 is further provided with a hole 313 extending from an outer surface to the first end 3140 of the hollow 314. The hole 313 is arranged close to the first end 3140 of the hollow 314. The hole 313 is an operation hole for a user to connect the first couple wire 341 and the second couple wire 342 to the susceptor 31 at the first end 3140 of the hollow 314.

Specifically, the first couple wire 341 and the second couple wire 342 extend into the hollow 314, and substantially abut against the first end 3140 of the hollow 314; and at least a part of the first couple wire 341 and at least a part of the second couple wire 342 are visible through the hole 313. Further, a manner such as laser lighting or solder injection is applied through the hole 313, so that another operation such as welding is performed on the first couple wire 341 and the second couple wire 342 to the susceptor 31 at the first end 3140 of the hollow 314 to form a connection, and a temperature of the susceptor 31 can be stably measured.

Further, there are insulating coatings on surfaces of the first couple wire 341 and the second couple wire 342, so that the first couple wire 341 and the second couple wire 342 are insulated from the susceptor 31. In some implementations, the insulating coatings may be prepared on the first couple wire 341 and the second couple wire 342 through a process such as spray coating, dip coating, vacuum coating, or high temperature oxidation.

Alternatively, in another varying implementation, the temperature sensor may also be a finished thermocouple-type sensor that is prepared, for example, a K-type or J-type armored thermocouple. After a probe part of the armored thermocouple extends into the first end 3140 of the hollow 314, a manner such as laser lighting or solder injection is applied through the hole 313 to connect the probe of the armored thermocouple to the susceptor 31. Alternatively, in some other varying implementations, the temperature sensor may also be a thermistor-type temperature sensor, such as PT1000.

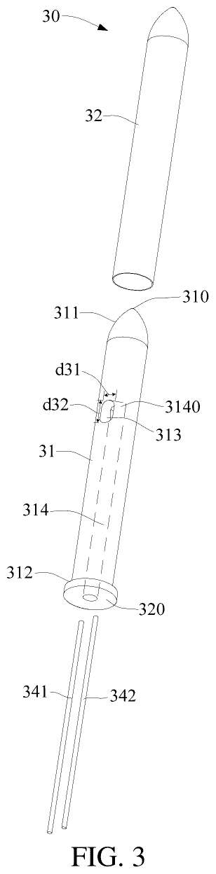

Further, refer to a preferred implementation shown in FIG. 3. The hole 313 is constructed into an elongated waist-shaped hole, which is an unconventional circular shape. Specifically, the hole 313 is constructed so that a size d32 of the hole 313 extending in the axial direction of the susceptor 31 is larger than a size d31 of the hole 313 extending in a circumferential direction of the susceptor 31. In some specific implementations, the size d31 is about 0.5 mm to 1.0 mm, and the size d32 is about 1.2 mm to 2 mm. Therefore, in an operation such as performing welding in a laser lighting manner or the like, there is a larger lighting angle in the length direction, which is more advantageous for production, preparation, and operation.

Further, in an implementation, the hole 313 is preferably a straight hole; or the hole 313 is at least a circuitous hole channel that does not reciprocate back and forth, which is advantageous for not interfering with rectilinear propagation of laser. Further, in a preferred implementation, the hole 313 is arranged in a radical direction of the susceptor 31.

Further, as shown from FIG. 2 to FIG. 5, the heater 30 further includes:
a protective layer 32, formed on and wrapping the outer surface of the susceptor 31. In addition, the protective layer 32 is for covering and wrapping the hole 313, so that the hole 313 is hidden or blocked on a surface of the heater 30. Therefore, smoke, debris, aerosol condensate, and the like derived from the aerosol generating product A are prevented from entering the hollow 314 through the hole 313.

In some implementations, the protective layer 32 may include an inorganic non-metallic material, for example, an insulating material such as an oxide (such as, MgO, SiO₂, Al₂O₃, or B₂O₃) or a nitride (such as, Si₃N₄, B₃N₄, or Al₃N₄), or another highly thermally conductive composite ceramic material. In an implementation, the protective layer 32 may be formed on the surface of the susceptor 31 through spray coating, dip coating, depositing, or the like. In a specific implementation, the protective layer 32 is a ceramic film or a glass glaze layer.

In some implementations, the protective layer 32 formed through spray coating, dip coating, depositing, or the like may have a thickness of about 0.1 mm to 0.5 mm.

Therefore, the protective layer 32 is formed through spray coating, depositing, or the like, and the surface of the heater 30 is smooth and flat. The protective layer 32 is opaque, so that the hole 313 is invisible on the surface of the heater 30.

Further, in the foregoing implementations, a sectional area of the hole 313 is limited below 2 mm²; and under such a sectional area size, when the protective layer 32 is formed through spray coating, dip coating, depositing, or the like, the hole 313 can be smoothly covered, and a flat surface can be formed.

Further, as shown from FIG. 2 to FIG. 5, the first couple wire 341 and the second couple wire 342 have extension lengths of about 25 mm to 60 mm. Therefore, after preparation or assembly, at least a part of the first couple wire 341 and at least a part of the second couple wire 342 are exposed outside the tail end 320, which is advantageous for a connection with the circuit 20 to facilitate performing sampling on the circuit 20 or obtaining a sensing result.

Another embodiment of this application further provides a method for preparing a heater 30, including the following steps:

S10: Obtain a susceptor 31 in a shape of a pin, a needle, a column, a rod, or the like, where the susceptor 31 has a hollow 314 and a hole 313.

S20: Extend a first couple wire 341 and a second couple wire 342 from an opening of a tail end 320 into the hollow 314, and make the first couple wire 341 and the second couple wire 342 abut against a first end 3140 of the hollow 314.

S30: Light laser at the first end 3140 of the hollow 314 through the hole 313, so that the first couple wire 341 and the second couple wire 342 are welded to the susceptor 31.

S40: Form a protective layer 32 such as a glaze layer on a surface of the susceptor 31 through spray coating, dip coating, or the like, to cover or protect the hole 313. In this way, the heater 30 is obtained.

For the foregoing heater 30, it is more convenient to connect the temperature sensor to the susceptor 31 through the hole 313.

It should be noted that, the specification of this application and the accompanying drawings thereof illustrate preferred embodiments of this application, but this application is not limited to the embodiments described in the specification. Further, a person of ordinary skill in the art may make improvements or variations according to the foregoing descriptions, and the improvements and variations shall all fall within the protection scope of the appended claims of this application.

1. An aerosol generating device, configured to heat an aerosol generating product to generate an aerosol, the aerosol generating device comprising:
a chamber for receiving the aerosol generating product;
a magnetic field generator configured to generate a varying magnetic field; and
a heater configured to heat the aerosol generating product,
wherein the heater comprises:
a susceptor, wherein at least a part of the susceptor extends in the chamber, wherein the susceptor is configured to be penetrated by the varying magnetic field to generate heat; and
wherein the susceptor has a hollow extending in an axial direction;
a temperature sensor configured to sense a temperature of the susceptor, wherein at least a part of the temperature sensor is located in the hollow; and
a hole penetrating from an outer surface of the susceptor to the hollow, wherein the hole is configured for providing a path for operating the temperature sensor, such that the temperature sensor is connected to the susceptor.

2. The aerosol generating device according to claim 1, wherein at least a part of the temperature sensor is visible through the hole.

3. The aerosol generating device according to claim 1, wherein the hole substantially extends in a radial direction of the susceptor.

4. The aerosol generating device according to claim 1, wherein a size of the hole in a length direction of the susceptor is larger than a size of the hole in a circumferential direction of the susceptor.

5. The aerosol generating device according to claim 4, wherein the size of the hole in the length direction of the susceptor ranges from 1.2 mm to 2 mm.

6. The aerosol generating device according to claim 1, wherein a sectional area of the hole is smaller than 2 mm².

7. The aerosol generating device according to claim 1, wherein the hollow comprises a termination end terminating in the susceptor, and the hole is close to the termination end.

8. The aerosol generating device according to claim 1, wherein the heater further comprises: a protective layer, bonded to the outer surface of the susceptor and covering the hole.

9. The aerosol generating device according to claim 1, wherein the temperature sensor comprises a first couple wire and a second couple wire connected to the susceptor; and the first couple wire and the second couple wire are made of different materials.

10. A heater of an aerosol generating device, comprising:
a susceptor configured to be penetrated by a varying magnetic field to generate heat, and constructed into an elongated shape extending in an axis, wherein the susceptor has a hollow extending in the axis;
a temperature sensor configured to sense a temperature of the susceptor, wherein at least a part of the temperature sensor is located in the hollow; and
a hole penetrating from an outer surface of the susceptor to the hollow, wherein the hole is for providing a path for operating the temperature sensor, such that the temperature sensor is fixedly connected to the susceptor.

11. The aerosol generating device according to claim 4, wherein the size of the hole in the circumferential direction of the susceptor ranges from 0.5 mm to 1.0 mm.

12. The aerosol generating device according to claim 2, wherein the hole substantially extends in a radial direction of the susceptor.

13. The aerosol generating device according to claim 2, wherein a size of the hole in a length direction of the susceptor is larger than a size of the hole in a circumferential direction of the susceptor.

14. The aerosol generating device according to claim 13, wherein the size of the hole in the length direction of the susceptor ranges from 1.2 mm to 2 mm.

15. The aerosol generating device according to claim 13, wherein the size of the hole in the circumferential direction of the susceptor ranges from 0.5 mm to 1.0 mm.

16. The aerosol generating device according to claim 2, wherein a sectional area of the hole is smaller than 2 mm².

17. The aerosol generating device according to claim 2, wherein the hollow comprises a termination end terminating in the susceptor, and the hole is close to the termination end.

18. The aerosol generating device according to claim 2, wherein the heater further comprises: a protective layer, bonded to the outer surface of the susceptor and covering the hole.

19. The aerosol generating device according to claim 2, wherein the temperature sensor comprises a first couple wire and a second couple wire connected to the susceptor; and the first couple wire and the second couple wire are made of different materials.
